(19) United States
(12) Patent Application Publication
(10) Pub. No.: US 2026/0219455 A1
(43) Pub. Date: Jul. 30, 2026

(54) High Slant Angle Gratings for Eye Glow Suppression in Waveguide Based Displays

(71) Applicant: DigiLens Inc., Sunnyvale, CA (US)

(72) Inventors: Alastair John Grant, San Jose, CA (US); Yuyu Li, Sunnyvale, CA (US)

(73) Assignee: DigiLens Inc., Sunnyvale, CA (US)

(21) Appl. No.: 19/147,464

(22) PCT Filed: Jan. 16, 2024
(86) PCT No.: PCT/US2024/011658

§ 371 Date: Jul. 11, 2025

Related U.S. Application Data
(60) Provisional application No. 63/479,884, filed on Jan. 13, 2023.

(51) Int. Cl. G02B 6/34; G02B 27/01

(52) U.S. Cl. CPC G02B 6/34; G02B 27/0101; G02B 2027/0118

(57) ABSTRACT

Disclosed herein is various waveguide-based displays. One particular waveguide-based display includes a bottom substrate supporting a slanted grating. The bottom substrate is configured to maintain light in total internal reflection (TIR). The bottom substrate has an eye box side through which light is extracted out of the substrate towards an eyebox and an eye glow side through which eyeglow is extracted out of the substrate towards the outside world. The slanted grating includes repeating diffracting features each having a slant angle which is the angle formed between a face of the diffracting features and a normal to the bottom substrate. The slant angle is above or equal to 40 degrees. Advantageously, the slanted grating is configured to diffracted or reflect the TIR light out of the eye box side with minimal light is diffracted or reflected out of the eyebox side.

### CROSS-REFERENCED APPLICATIONS

This application claims priority to U.S. Provisional Application 63/479,884 filed on Jan. 13, 2023, the disclosure of which is incorporated by reference in its entirety.

### FIELD OF THE INVENTION

The present invention generally relates to gratings which suppress eye glow in waveguide systems.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (TIR).

Fabrication of waveguides can include the use of material systems that allow for the recording of holographic optical elements within the waveguides. One class of such material includes polymer dispersed liquid crystal (PDLC) mixtures, which are mixtures containing photopolymerizable monomers and liquid crystals. A further subclass of such mixtures includes holographic polymer dispersed liquid crystal (HPDLC) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating. The resulting grating, which is commonly referred to as a switchable Bragg grating (SBG), has all the properties normally associated with volume or Bragg gratings but with much higher refractive index modulation ranges combined with the ability to electrically tune the grating over a continuous range of diffraction efficiency (the proportion of incident light diffracted into a desired direction). The latter can extend from non-diffracting (cleared) to diffracting with close to 100% efficiency.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (AR) and virtual reality (VR), compact head-up displays (HUDs) and helmet-mounted displays or head-mounted displays (HMDs) for road transport, aviation, and military applications, and sensors for biometric and laser radar (LIDAR) applications.

### SUMMARY OF THE INVENTION

In some aspects, the techniques described herein relate to a waveguide-based display including: a bottom substrate supporting a slanted grating, wherein the bottom substrate is configured to maintain light in total internal reflection (TIR), wherein the bottom substrate has an eye box side through which light is extracted out of the substrate towards an eyebox and an eye glow side through which eyeglow is extracted out of the substrate towards the outside world, wherein the slanted grating includes repeating diffracting features each having a slant angle which is the angle formed between a face of the diffracting features and a normal to the bottom substrate, wherein the slant angle is above or equal to 40 degrees, and wherein the slanted grating is configured to diffracted or reflect the TIR light out of the eye box side with minimal light diffracted or reflected out of the eyebox side.

In some aspects, the techniques described herein relate to a waveguide-based display, further including a top substrate, wherein the slanted grating is positioned between the top substrate and the bottom substrate and wherein the TIR light is maintained between the top substrate and the bottom substrate.

In some aspects, the techniques described herein relate to a waveguide-based display, wherein the slanted grating is configured to diffract the TIR light traveling from the eye glow side towards the eye box side of the bottom substrate out of the top substrate.

In some aspects, the techniques described herein relate to a waveguide-based display, wherein top substrate has an eye box side and an eye glow side, and wherein the slanted grating is configured to reflect the TIR light traveling from the eye box side towards the eye glow side of the top substrate out of the top substrate.

In some aspects, the techniques described herein relate to a waveguide-based display, wherein the slanted grating is configured to minimally diffract the TIR light traveling from the eye box side towards the eye glow side of the top substrate out of the bottom substrate.

In some aspects, the techniques described herein relate to a waveguide-based display, wherein the slanted grating is configured to minimally reflect the TIR light traveling from the eye glow side towards the eye box side of the bottom substrate out of the bottom substrate.

In some aspects, the techniques described herein relate to a waveguide-based display, wherein TIR light is configured to travel in TIR within the bottom substrate.

In some aspects, the techniques described herein relate to a waveguide-based display, wherein the slanted grating is positioned on the eye box side of the bottom substrate.

In some aspects, the techniques described herein relate to a waveguide-based display, wherein the slanted grating is configured to diffract the TIR light out of the bottom substrate.

In some aspects, the techniques described herein relate to a waveguide-based display, wherein the slanted grating is configured to minimally reflect the TIR light traveling from the eye glow side towards the eye box side of the bottom substrate out of the bottom substrate.

In some aspects, the techniques described herein relate to a waveguide-based display, wherein the slanted grating is an evacuated periodic structure.

In some aspects, the techniques described herein relate to a waveguide-based display, wherein the slanted grating is a volume Bragg grating.

In some aspects, the techniques described herein relate to a waveguide-based display, wherein the slant angle is the angle between a fringe plane of the grating and a direction orthogonal to the extending direction of the substrate bottom.

In some aspects, the techniques described herein relate to a waveguide-based display, wherein the slant angle of the diffracting features is between 40 degrees and 65 degrees.

In some aspects, the techniques described herein relate to a waveguide-based display, wherein the slant angle of the diffracting features is between 45 degrees and 60 degrees.

In some aspects, the techniques described herein relate to a waveguide-based display, wherein the slant angle of the diffracting features is between 50 and 60 degrees.

In some aspects, the techniques described herein relate to a waveguide-based display, wherein the slant angle of the diffracting features is above or equal to 45 degrees.

In some aspects, the techniques described herein relate to a waveguide-based display, wherein the slant angle of the diffracting features is above or equal to 50 degrees.

In some aspects, the techniques described herein relate to a waveguide-based display, wherein the slant angle of the diffracting features is above or equal to 55 degrees.

In some aspects, the techniques described herein relate to a waveguide-based display, wherein the slant angle of the diffracting features is above or equal to 60 degrees.

In some aspects, the techniques described herein relate to a waveguide-based display, further including an input grating supported by the bottom substrate, wherein the input grating diffracts light into total internal reflection (TIR) within the bottom substrate; and a fold grating, wherein the fold grating receives the TIR light and expands the TIR light in a first direction, wherein the slanted grating is configured as an output grating which receives the expanded light and outputs the light.

In some aspects, the techniques described herein relate to a waveguide-based display, wherein the fold grating includes a slanted grating including repeating diffracting features each having a slant angle above or equal to 40 degrees.

In some aspects, the techniques described herein relate to a waveguide-based display, wherein the slant angle of the fold grating is between 40 degrees and 65 degrees.

In some aspects, the techniques described herein relate to a waveguide-based display, wherein the slant angle of the fold grating is between 45 degrees and 60 degrees.

In some aspects, the techniques described herein relate to a waveguide-based display, wherein the slant angle of the fold grating is between 50 and 60 degrees.

In some aspects, the techniques described herein relate to a waveguide-based display, wherein the slant angle of the fold grating is above or equal to 45 degrees.

In some aspects, the techniques described herein relate to a waveguide-based display, wherein the slant angle of the fold grating is above or equal to 50 degrees.

In some aspects, the techniques described herein relate to a waveguide-based display, wherein the slant angle of the fold grating is above or equal to 55 degrees.

In some aspects, the techniques described herein relate to a waveguide-based display, wherein the slant angle of the fold grating is above or equal to 60 degrees.

### BRIEF DESCRIPTION OF THE DRAWINGS

The description will be more fully understood with reference to the following figures and data graphs, which are presented as various embodiment of the disclosure and should not be construed as a complete recitation of the scope of the disclosure, wherein:

FIG. 1A illustrates an example grating in accordance with an embodiment of the invention.

FIG. 1B illustrates an example grating in accordance with an embodiment of the invention.

FIG. 2 illustrates the general structure for the grating implemented in a waveguide in accordance with an embodiment of the invention.

FIG. 3 shows how the two transmission orders contribution to the diffraction efficiency (DE) versus angle in the eyebox and eyeglow directions.

FIG. 4 illustrates the contribution of the reflection diffraction orders to the diffraction efficiency versus angle in the eye box.

FIG. 5 shows various DE plots for various grating angles in the eye box for slant angles in the range 20 degrees to −20 degrees.

FIG. 6 shows eyeglow DE for various grating angles for the same range of slant angles.

FIG. 7 is a diagram of a high slant angle grating positioned on top of a substrate which forms a waveguide.

FIG. 8 illustrates the contribution of the reflection and transmission diffraction orders to the diffraction efficiency versus angle in the eye glow and eye box directions.

FIG. 9 illustrates various eyebox DE plots for various grating slant angles.

FIG. 10 illustrates various eye glow DE plots for various grating slant angles.

### DETAILED DESCRIPTION

For the purposes of describing embodiments, some well-known features of optical technology known to those skilled in the art of optical design and visual displays have been omitted or simplified in order to not obscure the basic principles of the invention. Unless otherwise stated, the term “on-axis” in relation to a ray or a beam direction refers to propagation parallel to an axis normal to the surfaces of the optical components described in relation to the invention. In the following description the terms light, ray, beam, and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. As used herein, the term grating may encompass a grating comprised of a set of gratings in some embodiments. For illustrative purposes, it is to be understood that the drawings are not drawn to scale unless stated otherwise.

In waveguide-based displays light may be diffracted toward the user and also away from the user. Eye glow may include unwanted light emerging from the front face of a display waveguide (e.g. the waveguide face furthest from the eye) and originating at a reflective surface of the eye, a waveguide reflective surface and a surface of grating (due to leakage, stray light diffractions, scatter, and other effects). The light that is diffracted away from the user is commonly called “eye-glow” and poses a liability for security, privacy, and social acceptability. This light if reflected off the face of the waveguide nearest the eye back into the waveguide may contribute to eyeglow. “Eye glow” may refer to the phenomenon in which a user's eyes appear to glow or shine through an eye display caused by leakage of light from the display, which creates an aesthetic that can be unsettling to some people. In addition to concerns regarding social acceptability in a fashion sense, eye glow can present a different issue where, when there is sufficient clarity to the eye glow, a viewer looking at the user may be able to see the projected image intended for only the user. As such, eye glow can pose a serious security concern for many users. There are many sources of eye glow in near-eye displays, including but not limited to Fresnel reflections and off-Bragg diffractions. This may be an issue for all diffractive waveguide solutions (surface relief gratings, volume Bragg gratings, etc.) and optical combiner methods that may utilize see-through. In addition to blocking unwanted eye-glow light, the waveguides may maintain high transmission to allow the observer to still see the real world. Furthermore, the need for eye contact drives a highly transparent waveguide while blocking eye-glow light. Suppressing eye-glow light may be a selective light blocking technique for all waveguide and optical combiner augmented reality or mixed reality wearable devices. Eye-glow suppression may also be applied to waveguide based heads-up displays such as automotive heads-up displays or aerospace applied heads-up displays. Many of the embodiments are directed to removing eyeglow which may also apply to the problem of stray light from many of the above the identified sources ending up in the eye box.

When eliminating eye glow from waveguide displays it is beneficial to strike a balance between configuring waveguide gratings to maximize image light propagation into the eyebox and directing any stray light away from paths that may be refracted through the front of the waveguide. Stray light here may include any image light that is not diffracted into the eyebox, due to diffraction inefficiencies, and haze produced by the grating material and grating imperfection. The stray light that emerges from the outer surface of the waveguide may contribute to eye glow. In many cases, at least some of the stray light may emerge from the waveguide via the inner (near-eye) surface of the waveguide. The light from the inner surface may scatter off the user's face which may provide some degree of eyeglow if it is refracted through the front of the waveguide. For stray light to emerge as eyeglow, it may strike the outer surface of the waveguide at an angle smaller than the critical angle. In many cases, light paths taken by such light may have a polarization rotation relative to the image light that propagates towards the eyebox. In many embodiments, eyeglow light may have a high concentration around grating regions within which multiple beam grating interactions may result in unwanted light extraction, as in the case of fold gratings and dual interaction gratings, for example. Previous examples of eye glow suppression in described extensively in U.S. Pat. Pub. No. 2022/0197026, entitled “Eye Glow Suppression in Waveguide Based Displays” and filed Dec. 20, 2021, which is hereby incorporated by reference in its entirety for all purposes.

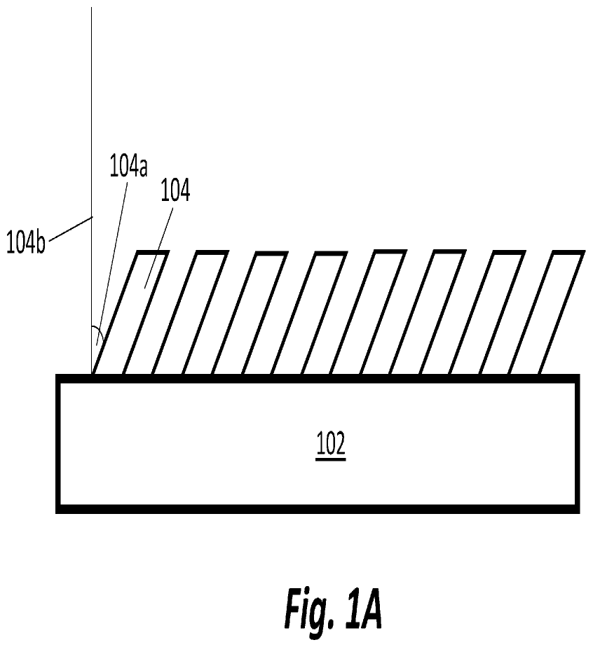

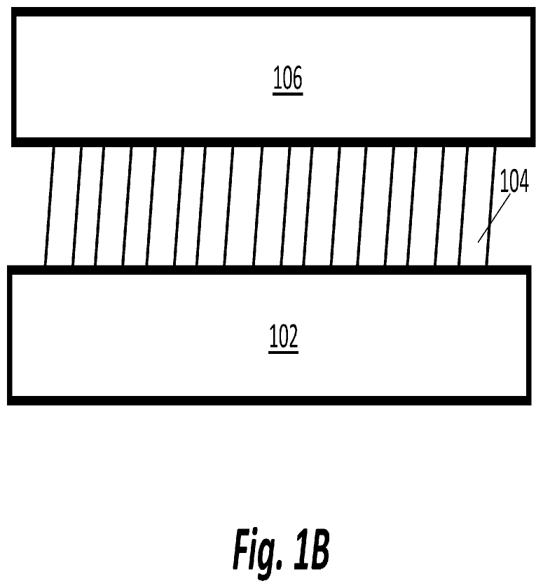

The disclosed eyeglow suppression systems may include high slant angle gratings for eye glow suppression. FIG. 1A illustrates an example grating in accordance with an embodiment of the invention. As illustrated a substrate 102 includes a grating 104 positioned on a surface. The substrate 102 may be a waveguide configured to propagate light in total internal reflection (TIR). The grating 104 may include a slant angle 104a which may be considered the angle between a fringe plane of the grating 104 and a direction orthogonal to the extending direction of the substrate 102. The grating 104 may include diffracting features or fringes may have various cross-section shapes based on parallelograms, trapezoids, triangles and other polygons. The diffracting features may be repeating. In some cases, the cross-section shapes may include curves. Various slant angles 104a are described in more detail below. The slant angle 104a may be formed between a normal plane 104b to the extending direction of the substrate 102 and the extending direction of the diffracting features of the grating 104. In some configurations, the grating 104 may be positioned between the substrate 102 and a cover substrate.

The grating may be utilized as an output grating which is configured to output light which is propagating in total internal reflection (TIR) within the substrate 102. The slanted grating 104 may be utilized in a waveguide-based display including an input grating supported by the substrate 102. The input grating diffracts light into total internal reflection (TIR) within the substrate 102. The waveguide-based display further includes a fold grating. The fold grating receives the TIR light and expands the TIR light in a first direction. The slanted grating 104 may be configured as an output grating which receives the expanded light and outputs the light. In some embodiments, more than one grating may be a high slant grating. For example, the fold grating may also be a high slant angle grating. Previously, the fold grating and the output grating contribute to eye glow. Thus, in some cases, both the fold and output grating may be high slant angle gratings.

In some embodiments, the slant angle 104a may be between 40 and 65 degrees. In some embodiments, the slant angle 104a may be between 45 and 60 degrees. In some embodiments, the slant angle 104a may be between 50 and 60 degrees. In some embodiments, the slant angle 104a may be higher than 60 degrees such as between 60 to 80 degrees.

FIG. 1B illustrates an example grating in accordance with an embodiment of the invention. The grating 104 is similar to in FIG. 1A however the grating 104 may be positioned between a bottom substrate 102 and a top substrate 106.

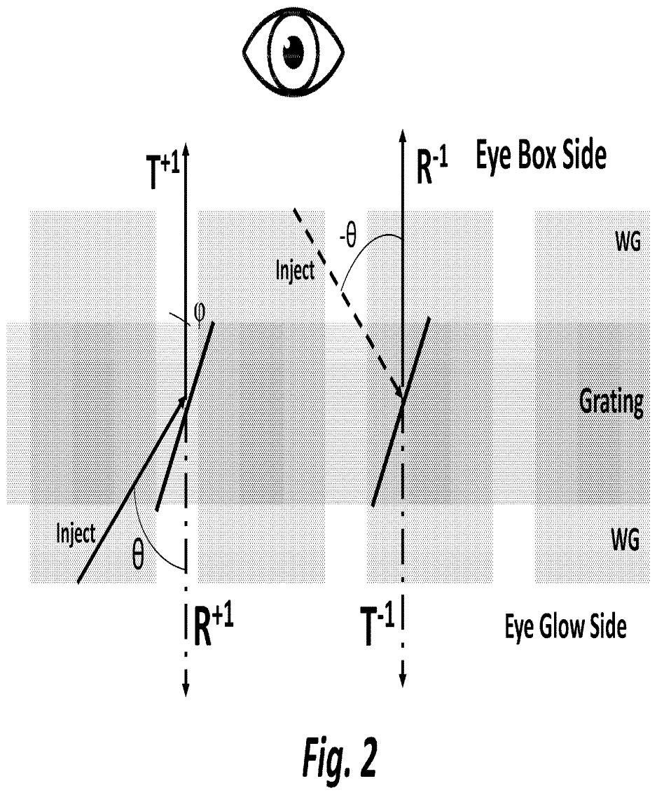

FIGS. 2-7 illustrate various aspects of various high slant angle gratings which eliminate eyeglow. The large slant angle grating is sandwiched by two substrates which form a waveguide. FIG. 2 illustrates the general structure for the grating implemented in a waveguide in accordance with an embodiment of the invention. In this waveguide, the transmission first order diffraction T⁺¹ and the reflection first order diffraction R⁻¹ both which propagate towards the eye box. The transmission diffraction T⁻¹ propagates in the eye glow direction. The general goal is to have all of the light propagate towards the eye box and have less light propagate towards the eye glow side which eliminates eye glow. Thus, it is advantageous to mitigate transmission diffraction T⁻¹.

FIG. 2 shows the diffraction orders T⁻¹, T⁺¹, R⁻¹, and R⁺¹ arising from diffraction of a ray injected into the waveguide by a grating of spatial period Λ. According to a grating equation, the diffracted orders are giving by 2n*Λ*sin (θ)=mλ where θ is the angle of the injected ray to the grating normal and m is an integer denoting the diffracted order. The 0-order resulting from each interaction of an injected ray with the grating. The 0-order ray propagates along the waveguide via total internal reflection at the waveguide substrate and air interfaces. It should be noted that, in some cases, high reflection orders may exist and could contribute to one or both of eyeglow and the eyebox illumination. To simplify the description of the embodiments we shall only consider the + and − orders.

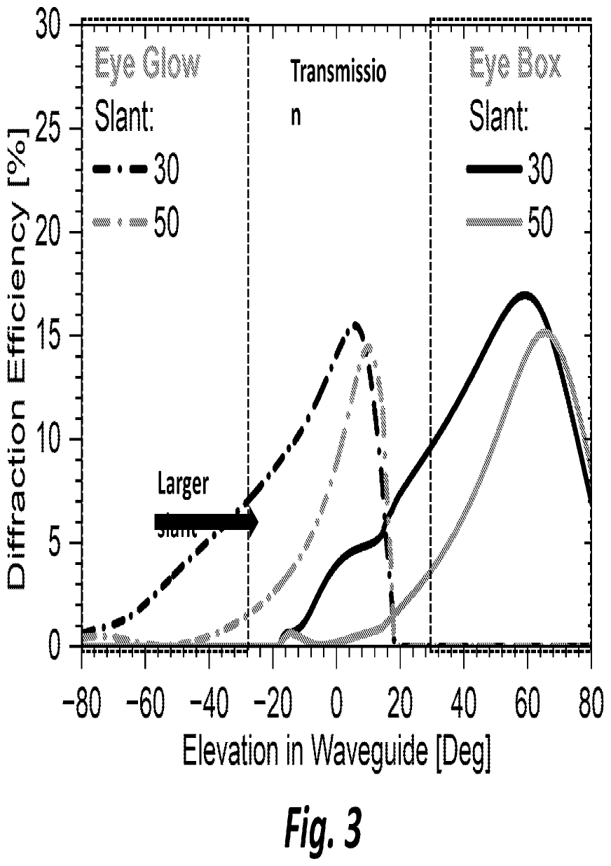

The slant angle may be defined as the angle between the surface of a diffracting feature or fringe and the normal to the surface as indicated by the symbol q in FIG. 2. The orders R⁺¹ and T⁻¹ both contribute to eye glow, while the orders T⁺¹ and R⁻¹ both contribute to the illumination received in the eyebox. The convention for injection angle (θ) and the directions of the transmission and reflection diffraction orders as shown in FIG. 2 applies to the examples presented in FIGS. 3-10. The diffraction efficiencies and eyeglow for both SRG and VBG gratings include upward and downward interactions with the grating resulting from total internal reflection.

FIG. 3 shows how the two transmission orders contribution to the diffraction efficiency (DE) versus angle in the eyebox and eyeglow directions. For a waveguide based display, the usable elevation in the waveguide is between 30 degrees and 80 degrees which is outlined by the dotted blue box. The dotted lines correspond to the eye glow transmission diffraction T⁻¹ whereas the solid lines correspond to the transmission first order diffraction T⁺¹. The usable transmission first order diffraction T⁺¹ occurs between 30 degrees and 80 degrees. As illustrated, while a higher slant angle of the gratings lowers the diffraction efficiency in this range, there is still significant first order diffraction T⁺¹ between 30 degrees and 80 degrees. The corresponding eye glow transmission diffraction T⁻¹ occurs at −30 degrees to −80 degrees. As illustrated, the corresponding eye glow transmission diffraction T⁻¹ significantly decreases at higher grating slant angles.

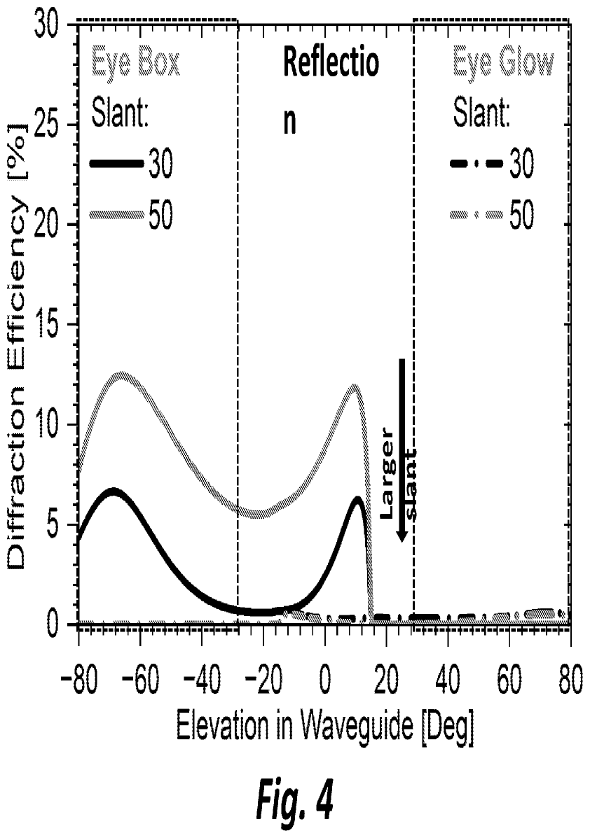

FIG. 4 illustrates the contribution of the reflection diffraction orders to the diffraction efficiency versus angle in the eye box. In each case slant angles of 30 degrees and 50 degrees are considered. The solid lines correspond to the reflection first order diffraction R⁻¹ whereas the dotted lines correspond to reflection diffraction. The usable elevation in waveguide is between −30 degrees and −80 degrees which is opposite to the usable transmission elevation in the waveguide. As illustrated larger slant angles shift the T⁻¹ diffraction outside of the eye glow box without significantly reducing the eye side efficiency. Also as illustrated, a minimal first order reflection which would be directed to the eye glow side is not observed.

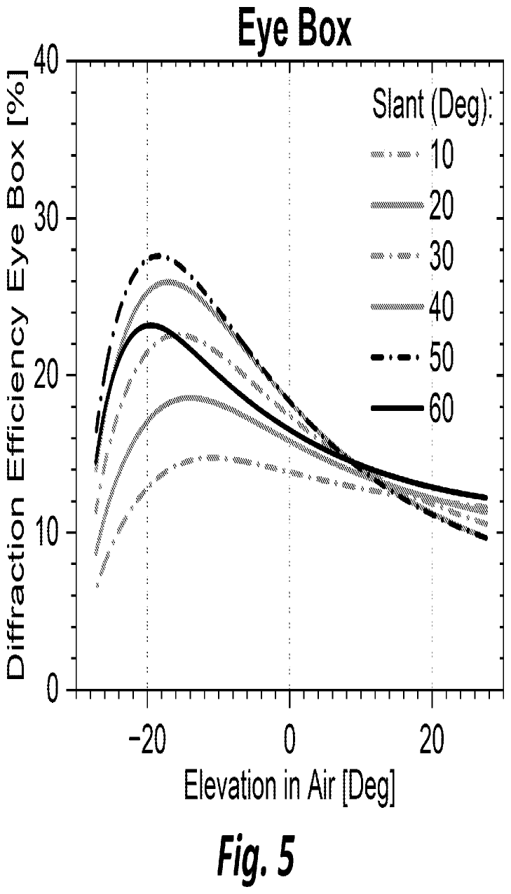

FIG. 5 shows various DE plots for various grating angles in the eye box for slant angles in the range 20 degrees to −20 degrees. The DE is plotted in relation to the elevation in air in degrees. The elevation in air is the output angle. Thus, the elevation in air of −20 degrees to 20 degrees corresponds to 35 degrees to 75 degrees elevation in the waveguide for FIG. 3 and −35 degrees to −75 degrees in the waveguide for FIG. 4.

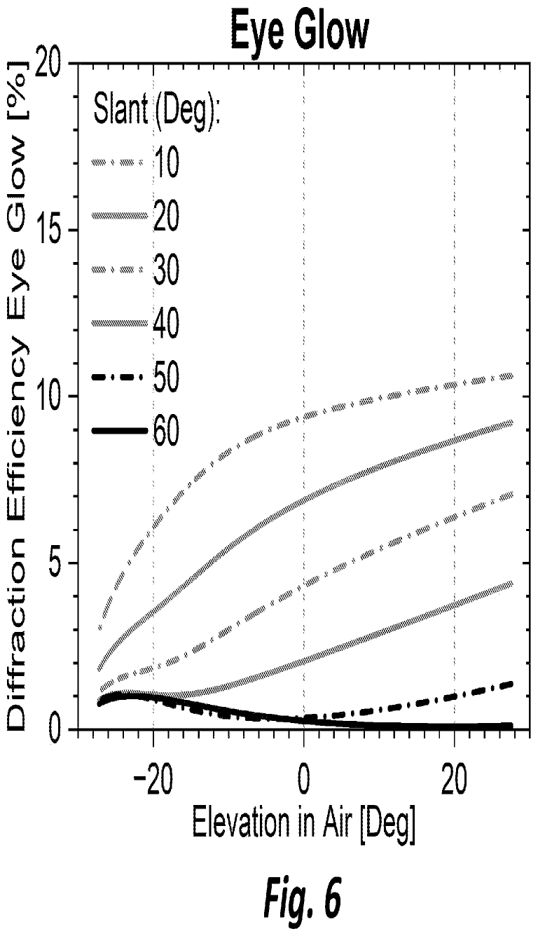

FIG. 6 shows eyeglow DE for various grating angles for the same range of slant angles. The elevation in air of −20 degrees to 20 degrees corresponds to 35 degrees to 75 degrees in the waveguide for FIG. 3. As illustrated, the DE on the eye box side peaks around 50 degrees in the waveguide and a larger slant angle may suppress eye glow significantly.

As illustrated, higher slant angle gratings may provide lower eye glow. In some embodiments, the grating may include a slant angle between 40 and 65 degrees. In some embodiments, the grating may include a slant angle between 45 and 60 degrees. In some embodiments, the grating may include a slant angle may be between 50 and 60 degrees. In some embodiments, the grating may include a slant angle higher than 60 degrees such as between 60 to 80 degrees.

The grating may include a volume Bragg grating (VBG). The grating may be an evacuated periodic structure (EPS). Examples of EPS structures and methods of manufacturing EPS structures are described in U.S. Pat. No. 11,442,222, entitled “Evacuated gratings and methods of manufacturing” and filed Aug. 28, 2020, and U.S. Pat. Pub. No. 2022/0283376, entitled “Evacuated Periodic Structures and Methods of Manufacturing” and filed Mar. 7, 2022, which are hereby incorporated by reference in their entirety for all purposes. Larger slant angles shift the T⁻¹ diffraction outside of the eye glow region, without significantly reducing the eye side efficiency. The grating may be an EPS including a subsequent backfilling which is described in both U.S. Pat. No. 11,442,222 and U.S. 2022/0283376. As described, the grating may include a varied slant angle.

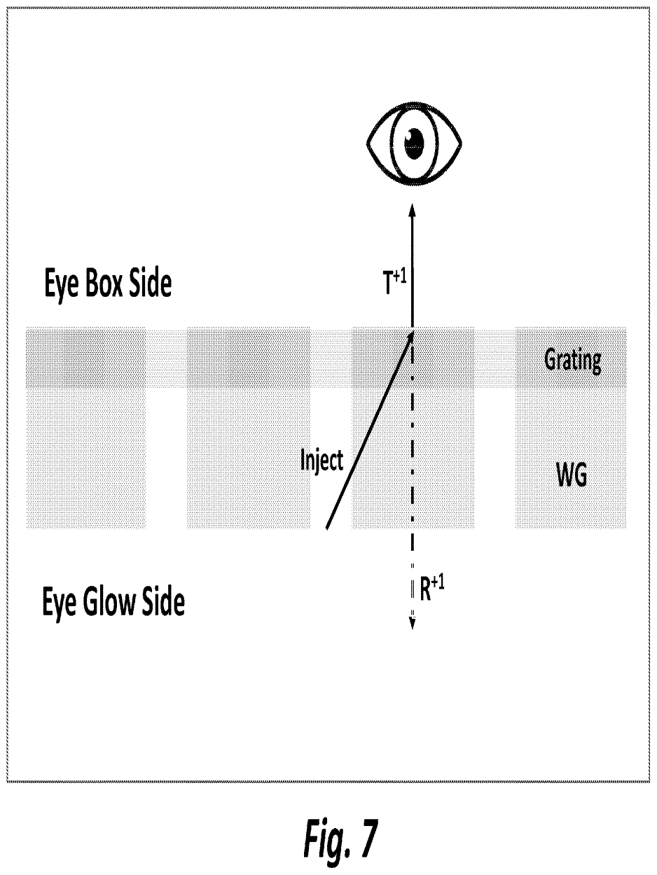

FIGS. 7-10 illustrate various aspects of various high slant angle gratings which eliminate eyeglow in accordance with various embodiments of the invention. FIG. 7 is a diagram of a high slant angle grating positioned on top of a substrate which forms a waveguide. This differs from the configuration described in FIGS. 2-6 where the large slant angle grating is positioned between two substrates. The large slant angle grating may be an EPS grating which diffracts incident light into diffracted light T⁺¹ and reflected light R⁺¹. In this waveguide, the diffracted light T⁺¹ propagates towards the eye box. The reflected light R⁺¹ propagates in the eye glow direction. The general goal is to have all of the light propagate towards the eye box and have less light propagate towards the eye glow side, which eliminates eye glow. Thus, it is advantageous to mitigate reflected light R⁺¹.

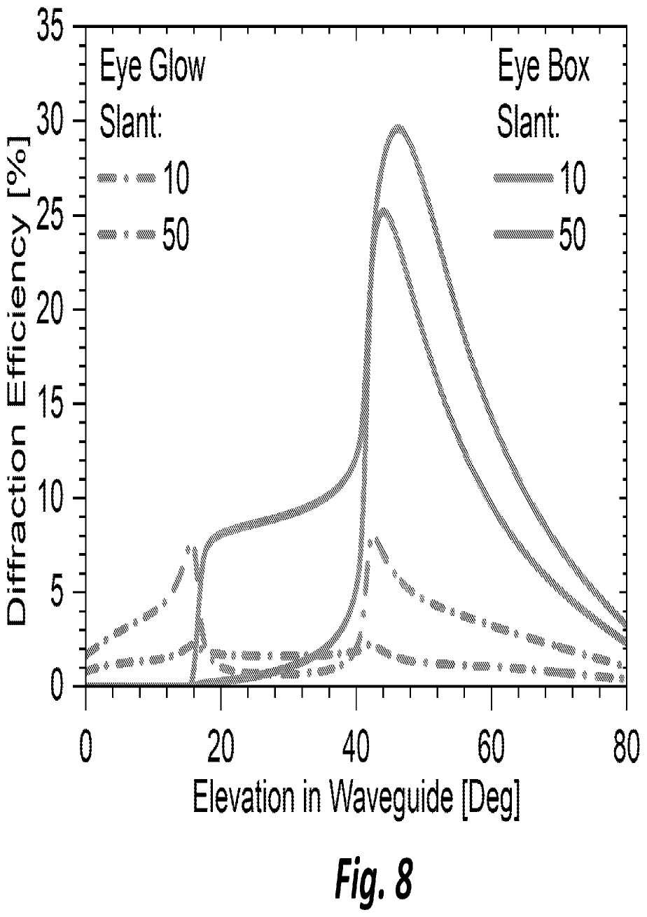

FIG. 8 illustrates the contribution of the reflection and transmission diffraction orders to the diffraction efficiency versus angle in the eye glow and eye box directions. The dotted lines represent the eye glow side reflected light R⁺¹. The solid lines represent the eye box diffracted light T⁺¹. In this configuration, slant angles of 10 degrees and 50 degrees are considered. The red lines represent a slant angle of 10 degrees whereas the blue lines represent a slant angle of 50 degrees. The usable elevation in waveguide is 35 degrees to 75 degrees. As illustrated, the eye box diffracted light T⁺¹ increases while the eye glow side reflected light R⁺¹ decreases over the elevation in waveguide of 35 degrees to 75 degrees.

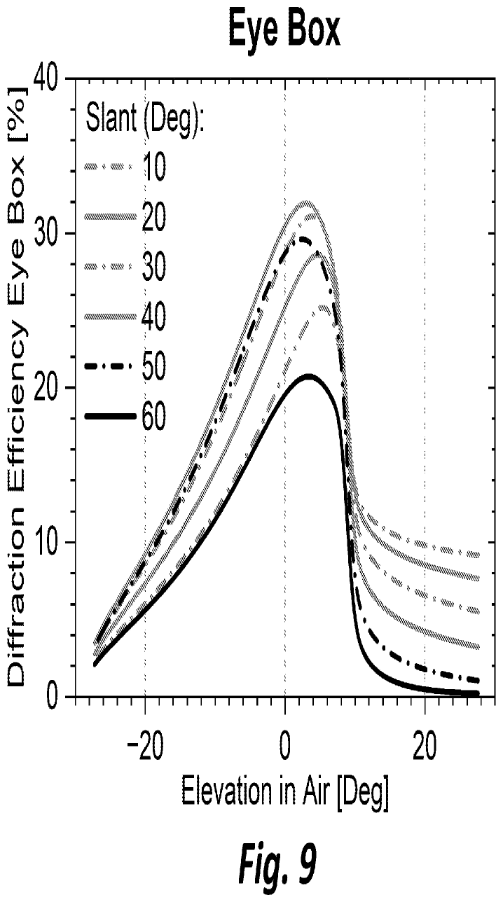

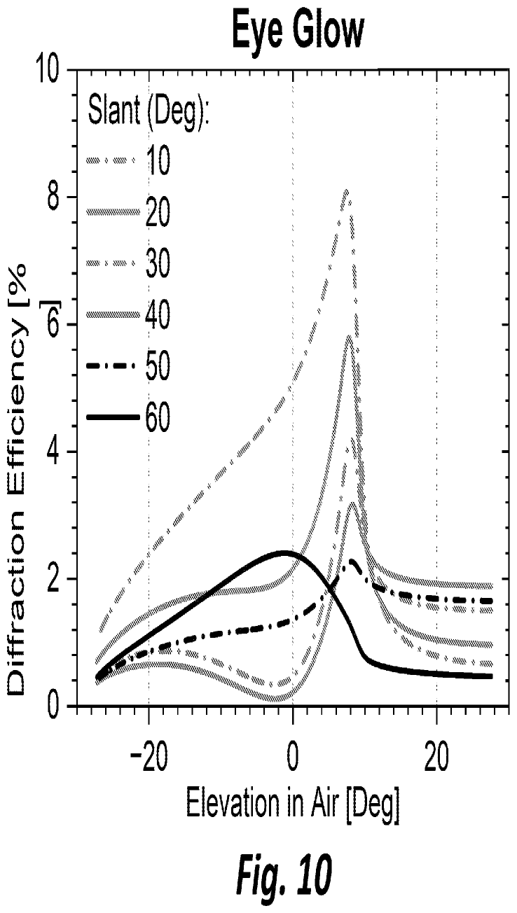

FIG. 9 illustrates various eyebox DE plots for various grating slant angles. In these plots, 35 degrees to 75 degrees elevation in waveguide is equivalent to −20 degrees to 20 degrees in air. FIG. 10 illustrates various eye glow DE plots for various grating slant angles. As illustrated, a higher slant angle decreases eye glow with eye glow being substantially mitigated at 50 degrees.

The grating may be an EPS structure. The grating may be a surface mounted VBG structure. As illustrated, larger slant angle shifts the R⁺¹ diffraction peak outside of the waveguide boundary, without significantly reducing the eye side efficiency. The grating may include a varied slant angle. DE on the eye box side may peak around 45 degrees. It has been discovered that eye glow may be at a minimum value close to 50 degrees.

Thus, as illustrated for both the case where the grating is positioned between two substrates and the grating is positioned on top of a single substrate, a higher slant angle has been discovered to minimize eye glow. The grating may have a slant angle above or equal to 40 degrees, 45 degrees, 50 degrees, 55 degrees, or 60 degrees. In some embodiments, the grating may include a slant angle between 40 and 65 degrees. In some embodiments, the grating may include a slant angle between 45 and 60 degrees. In some embodiments, the grating may include a slant angle between 50 and 60 degrees. In some embodiments, the grating may include a slant angle of about 50 degrees. In some embodiments, the grating may include a slant angle between 45 and 55 degrees.

### Example Manufacturing Methods for High Slant Angle Gratings

High slant angle gratings may be recorded using conventional two beam holographic recording techniques in which the beams are angled. There may be some spacing for holographic material shrinkage to accommodate specific slant angles. Various modifications of conventional recording may be used to increase the slant angle. In one approach holographic exposure may employ light of a shorter wavelengths than the replay wavelength to minimize recording beam angles. In another modification of a conventional recording set up, prism coupling and/or masters mounted to index matched prisms may be used.

Various other methods for fabricating high slant angle gratings are utilized. In one approach natural shrinkage may increase the slant angle while maintaining the surface spatial frequency of the gratings. Shrinkage is known to result from monomer polymerization and crosslinking of polymer chains. When monomers react and bind with a growing polymer radical, free volume is generated since the covalent single carbon bond in the polymer is as much as 50% shorter than the van der Waals bond in the liquid monomer state. The mechanical response of the medium to reduce this free volume leads to physical shrinkage of the system. The formation of the single bond in the polymer, leaves a temporary hole in the medium, which then collapses with a relaxation rate constant that is characteristic of the system. The degree of shrinkage may be influenced by recording intensity. Higher shrinkage may occur at lower recording intensities and in thinner layers. Higher shrinkage may occur in a two-beam recording set up if one of the beams is temporarily removed. In some cases, diffractive nanostructures may include composites of different polymer networks with differing shrinkage characteristics. The differential shrinkage may create shear stresses resulting in an increase in slant angle. The composite polymer networks may be formed from a plurality of monomers with different diffusivities that give rise to a series of gelation stages resulting in stratification of the final polymer network. Such processes may also be influenced by the functionalities of the monomers.

Application of pressure orthogonal to grating plane during curing may be used to increase slant angle by reducing the grating thickness while maintaining the grating spatial frequency. Mechanical shear forces may be applied to the substrates sandwiching the grating during curing. One of the substrates may also function as a release layer. The holographic recording mixture may contain additives that influence the polymerization such that the resulting diffracting nanostructures are more amenable to mechanical deformation. Mechanical pressure or shear may be applied before or after removal of the inert material component during the EPS process.

In some examples, the high slant angle gratings may also be manufactured utilizing a fabrication process using a nano-imprint lithography process including directional etching. Ashing and coating processes employed in EPS fabrication may be used to adjust the shapes of diffractive nanostructures to increase slant angle.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A waveguide-based display comprising:
a bottom substrate supporting a slanted grating,
wherein the bottom substrate is configured to maintain light in total internal reflection (TIR),
wherein the bottom substrate has an eye box side through which light is extracted out of the substrate towards an eyebox and an eye glow side through which eyeglow is extracted out of the substrate towards the outside world,
wherein the slanted grating includes repeating diffracting features each having a slant angle which is the angle formed between a face of the diffracting features and a normal to the bottom substrate,
wherein the slant angle is above or equal to 40 degrees, and
wherein the slanted grating is configured to diffracted or reflect the TIR light out of the eye box side with minimal light is diffracted or reflected out of the eyebox side.

2. The waveguide-based display of claim 1, further comprising a top substrate, wherein the slanted grating is positioned between the top substrate and the bottom substrate and wherein the TIR light is maintained between the top substrate and the bottom substrate.

3. The waveguide-based display of claim 2, wherein the slanted grating is configured to diffract the TIR light traveling from the eye glow side towards the eye box side of the bottom substrate out of the top substrate.

4. The waveguide-based display of claim 3, wherein top substrate has an eye box side and an eye glow side, and
wherein the slanted grating is configured to reflect the TIR light traveling from the eye box side towards the eye glow side of the top substrate out of the top substrate.

5. The waveguide-based display of claim 4, wherein the slanted grating is configured to minimally diffract the TIR light traveling from the eye box side towards the eye glow side of the top substrate out of the bottom substrate.

6. The waveguide-based display of claim 2, wherein the slanted grating is configured to minimally reflect the TIR light traveling from the eye glow side towards the eye box side of the bottom substrate out of the bottom substrate.

7. The waveguide-based display of claim 1, wherein TIR light is configured to travel in TIR within the bottom substrate.

8. The waveguide-based display of claim 7, wherein the slanted grating is positioned on the eye box side of the bottom substrate.

9. The waveguide-based display of claim 8, wherein the slanted grating is configured to diffract the TIR light out of the bottom substrate.

10. The waveguide-based display of claim 9, wherein the slanted grating is configured to minimally reflect the TIR light traveling from the eye glow side towards the eye box side of the bottom substrate out of the bottom substrate.

11. The waveguide-based display of claim 1, wherein the slanted grating is an evacuated periodic structure.

12. The waveguide-based display of claim 1, wherein the slanted grating is a volume Bragg grating.

13. The waveguide-based display of claim 1, wherein the slant angle is the angle between a fringe plane of the grating and a direction orthogonal to the extending direction of the substrate bottom.

14. The waveguide-based display of claim 1, wherein the slant angle of the diffracting features is between 40 degrees and 65 degrees.

15. The waveguide-based display of claim 14, wherein the slant angle of the diffracting features is between 45 degrees and 60 degrees.

16. The waveguide-based display of claim 15, wherein the slant angle of the diffracting features is between 50 and 60 degrees.

17. The waveguide-based display of claim 1, further comprising an input grating supported by the bottom substrate, wherein the input grating diffracts light into total internal reflection (TIR) within the bottom substrate; and
a fold grating, wherein the fold grating receives the TIR light and expands the TIR light in a first direction,
wherein the slanted grating is configured as an output grating which receives the expanded light and outputs the light.

18. The waveguide-based display of claim 17, wherein the fold grating comprises a slanted grating including repeating diffracting features each having a slant angle above or equal to 40 degrees.

19. The waveguide-based display of claim 18, wherein the slant angle of the fold grating is between 40 degrees and 65 degrees.

20. The waveguide-based display of claim 19, wherein the slant angle of the fold grating is between 45 degrees and 60 degrees.
